(19) United States
(12) Patent Application Publication
(10) Pub. No.: US 2026/0330718 A1
(43) Pub. Date: Oct. 22, 2026

(54) SYSTEMS AND METHODS FOR GENERATING CUSTOMIZED RENDERINGS FOR GRAPHICAL USER INTERFACES USING GENERATIVE AI AND REAL TIME FEEDBACK

(71) Applicant: BANK OF AMERICA CORPORATION, Charlotte, NC (US)

(72) Inventors: Kathlyn Rooney, Boston, MA (US); Marshall A. Johnson, Summit, NJ (US); Ana Maxim, Arlington, VA (US); Scott R. Enscoe, Waxhaw, NC (US); Jeremy Geiman, New York, NY (US); Glenn Seagraves, Denver, NC (US)

(73) Assignee: BANK OF AMERICA CORPORATION, Charlotte, NC (US)

(21) Appl. No.: 19/180,476

(22) Filed: Apr. 16, 2025

(51) Int. Cl. G06T 11/60; G06F 3/0481

(52) U.S. Cl. CPC G06T 11/60; G06F 3/0481; G06T 2200/24

(57) ABSTRACT

Systems, computer program products, and methods are described herein for generating customized renderings for graphical user interfaces using generative AI and real-time feedback. The present disclosure is configured to collect user data associated with a user account; apply the user data to a digital twin associated with the user account; apply the user data to a generative artificial intelligence (AI) engine; generate, by the generative AI engine, a prototype for a user associated with the user account; analyze, by the digital twin, the prototype; and customize the prototype for the user based on the analysis by the digital twin.

### TECHNOLOGICAL FIELD

Example embodiments of the present disclosure relate to generating customized renderings for graphical user interfaces using generative AI and real time feedback.

### BACKGROUND

In today's electronic environment, more and more information is presented in a digital format to different users. A large problem exists in the determination of what is the best way to present this information via a rendering to different users that may have different preferences, different capabilities, or different problems. For instance, as more users access these digital renderings, the more likely there may be a problem with the rendering presenting in an easily readable, and interactable manner to each user. Such problems are also seen in web applications generated broadly for all users and for different real-world products that are generated broadly for all users. Thus, a great need exists for a system that can efficiently, and with minimal user interaction, generate customized renderings or products using generative AI, digital twins of users, and real time feedback.

Applicant has identified a number of deficiencies and problems associated with generating customized renderings and/or products using generative AI and real time feedback. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for generating customized renderings for graphical user interfaces using generative AI and real time feedback.

In one aspect, a system for generating customized renderings for graphical user interfaces using generative AI and real-time feedback is provided. In some embodiments, the system may comprise: a memory device with computer-readable program code stored thereon; at least one processing device operatively coupled to the memory device and at least one communication device, wherein executing the computer-readable code is configured to cause the at least one processing device to: collect user data associated with a user account; apply the user data to a digital twin associated with the user account; apply the user data to a generative artificial intelligence (AI) engine; generate, by the generative AI engine, a prototype for a user associated with the user account; analyze, by the digital twin, the prototype; and customize the prototype for the user based on the analysis by the digital twin.

In some embodiments, the analysis by the digital twin comprises at least one interaction by the at least one digital with the prototype.

In some embodiments, the at least one prototype comprises at least one of an application, a product, or a graphical user interface.

In some embodiments, the at least one prototype comprises an application or a graphical user interface, and wherein executing the computer-readable code is configured to cause the at least one processing device to: identify at least one selectable icon on the graphical user interface or in the application; determine, based on the digital twin, a preferred location of the at least one selectable icon, wherein the preferred location is specific to the user associated with the digital twin; and customize the prototype by automatically moving the at least one selectable icon to the preferred location.

In some embodiments, the at least one prototype comprises a product, and wherein executing the computer-readable code is configured to cause the at least one processing device to: identify at least one product need for the user account; generate, by the generative AI engine, the product configured to meet the at least one product need; and reconfigure the product based on the analysis by the digital twin.

In some embodiments, the user data is collected from at least one of historical surveys of the user, historical physical feedback, historical behavioral data, or historical interaction data.

In some embodiments, the digital twin comprises a plurality of digital twins associated with a plurality of users, and wherein the generative AI engine is trained with the user data from the plurality of users. In some embodiments, the prototype is generated for the plurality of users and the prototype comprises a general user trend. In some embodiments, executing the computer-readable code is configured to cause the at least one processing device to: collect user feedback corresponding to the customized prototype from the plurality of users; and retrain the generative AI engine and the plurality of digital twins based on the user feedback.

In some embodiments, executing the computer-readable code is configured to cause the at least one processing device to: collect user feedback corresponding to the customized prototype from the user; and retrain the generative AI engine and the digital twin based on the user feedback.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating customized renderings for graphical user interfaces using generative AI and real time feedback, in accordance with an embodiment of the disclosure;

FIG. 2 illustrates an exemplary generative AI subsystem, in accordance with an embodiment of the disclosure;

FIG. 3 illustrates a process flow for generating customized renderings for graphical user interfaces using generative AI and real time feedback, in accordance with an embodiment of the disclosure;

FIG. 4 illustrates a process flow for customizing the prototype based on a preferred location of a selectable icon in the prototype, in accordance with an embodiment of the disclosure;

FIG. 5 illustrates a process flow for determining a product need and generating a prototype to meet the product need, in accordance with an embodiment of the disclosure; and

FIG. 6 illustrates a process flow for collecting real time feedback from one or more users associated with one or more digital twins, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's electronic environment, more and more information is presented in a digital format to different users. A large problem exists in the determination of what is the best way to present this information via a rendering to different users that may have different preferences (e.g., preferences for font, images, button placements, and/or the like), different capabilities, or different problems (e.g., color blindness, preference for fonts due to visual impairments, and/or the like). For instance, as more users access these digital renderings, the more likely there may be a problem with the rendering presenting in an easily readable, and interactable manner to each user. Such problems are also seen in web applications generated broadly for all users and for different real-world products that are generated broadly for all users. Thus, a great need exists for a system that can efficiently, and with minimal user interaction, generate customized renderings or products using generative AI, digital twins of users, and real time feedback.

Accordingly, the present disclosure provides for the collection of user data associated with a user account; the application of the user data to a digital twin associated with the user account; the application of the user data to a generative artificial intelligence (AI) engine; and the generation, by the generative AI engine, of a prototype for a user associated with the user account. Further, the disclosure provides for an analyzation, by the digital twin, of the prototype; and the customization of the prototype for the user based on the analysis by the digital twin.

In other words, the disclosure provides a system using a generative AI engine to generate customized renderings for users based on collecting individual user data and training a generative AI engine to create visualizations of customized products, interfaces, and/or the like. In some embodiments, the generative AI engine may generate a prototype of a product that is customized to the needs of the user (e.g., a prototype of an application or a window within an already existing application, and/or the like). Further, and in some instances, a user (and/or their digital twin) may—in real time—provide feedback for the prototype and the generative AI engine may update the prototype based on this feedback (e.g., moving a clickable button to a more accessible location or increasing the size of the button). In some embodiments, the training of the generative AI engine may be based on a collection of data from a plurality of users. In some embodiments, a digital twin may be trained on user data to mirror a user associated with the system, and the digital twin may interact with the prototype to generate feedback for the generative AI engine to customize or update the prototype to better meet the needs of the user (e.g., modify the prototype's buttons, font, image placement, information placement, and/or the like). In some embodiments, a digital agent/twin may be used for one or more users to train the generative AI agent on a plurality of users or for a single user. Thus, and in some embodiments, the prototype or product may be the same across all users that need the prototype, but certain features (e.g., buttons, colors, and/or the like) may be customized to individual users.

What is more, the present disclosure provides a technical solution to a technical problem. As described herein, the technical problem includes the generation of customized renderings and/or products using generative AI and real time feedback. The technical solution presented herein allows for the use of a pretrained generative AI engine designed to generate a prototype to meet a need for one or more users and digital twins of the one or more users to interact with and give feedback for the prototype. Such feedback may then be used to update or customize the prototype to allow for better operability by the one or more users. In particular, the disclosure provided herein is an improvement over existing solutions to the generation and customization of prototypes (e.g., graphical user interfaces, applications, and/or the like), (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

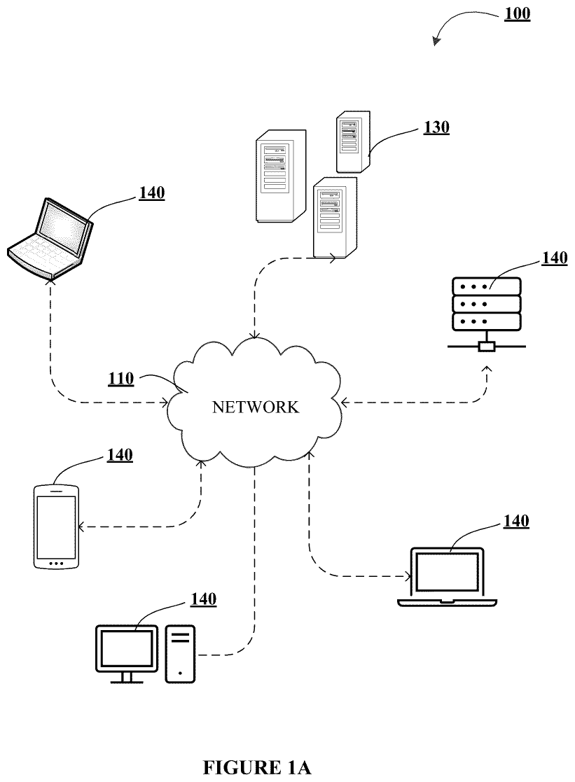

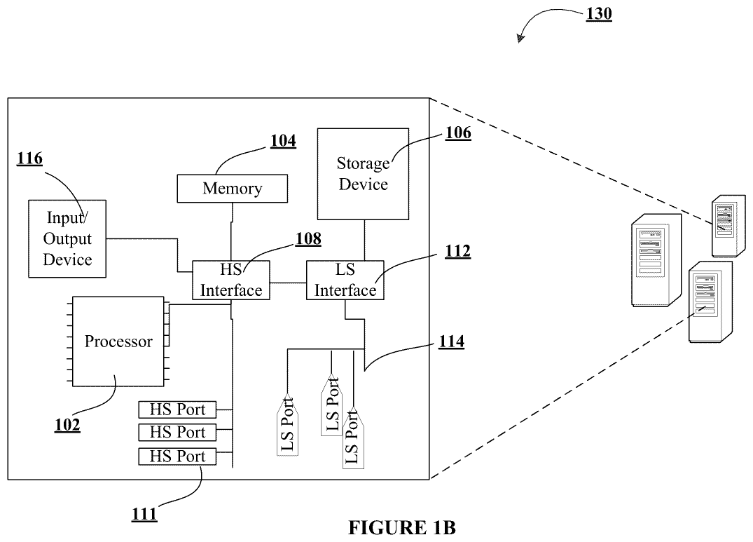

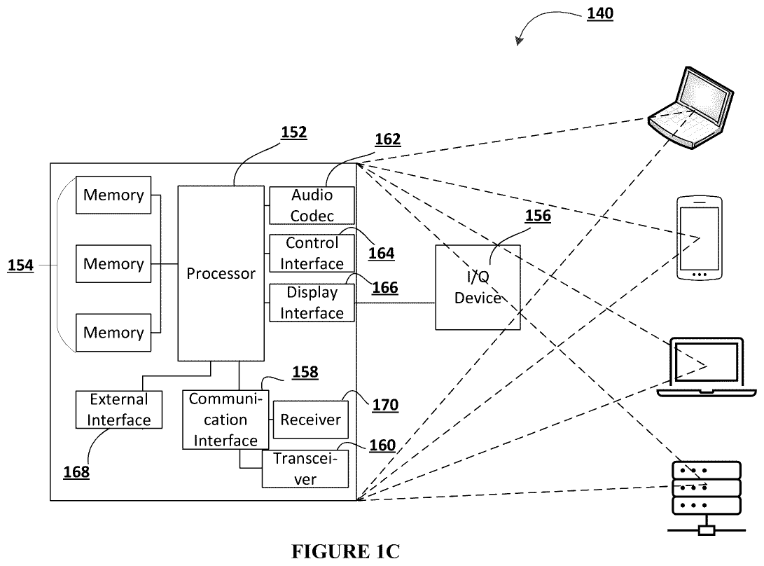

FIGS. 1A-1C illustrate technical components of an exemplary distributed computing environment for generating customized renderings for graphical user interfaces using generative AI and real time feedback 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

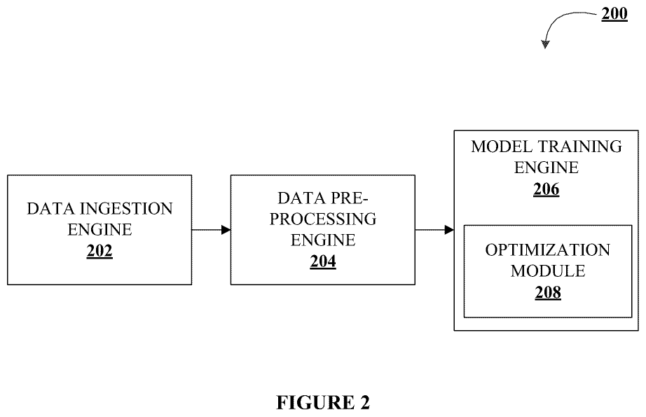

FIG. 2 illustrates an exemplary generative AI subsystem 200, in accordance with an embodiment of the disclosure. The generative AI subsystem 200 may include a data ingestion engine 202, a data pre-processing engine 204, and a model training engine 206. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 202 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 200 may utilize one or more machine learning techniques to generate new content. In machine learning, the quality of data and the useful information that may be derived therefrom directly affects the ability of the machine learning model to learn. The data pre-processing engine 204 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that may be suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training engine 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data may be used to update the model's parameters, while the validation and testing datasets may be reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206, which includes an optimization module 208, may implement various optimization techniques to improve model performance and efficiency. The optimization module 208 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 208 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

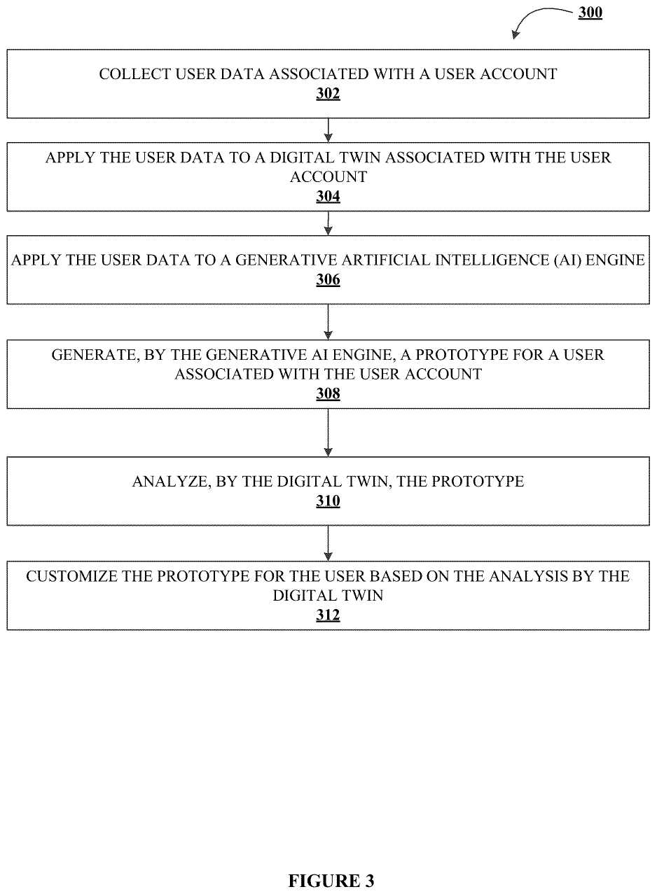

FIG. 3 illustrates a process flow 300 for generating customized renderings for graphical user interfaces using generative AI and real time feedback, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, a generative artificial intelligence (AI) engine (e.g., such as the generative AI engine shown in FIG. 2) may perform some or all the steps described in process flow 300.

As shown in block 302, the process flow 300 may include the step of collecting user data associated with a user account. For example, the system may collect user data for one or more users associated with the system, user associated with a client of the system (e.g., a client using the system to generate customized prototypes and/or renderings for the user), and/or the like. In some embodiments, the user data may be collected from a database or index configured to store historical interactions by the user with applications, graphical user interfaces, products, and/or the like. In some embodiments, the user data may comprise interactions and user inputs by the user(s) from surveys presented to the user (e.g., surveys asking for user opinions on historical products, applications, graphical user interfaces, and/or the like), physical feedback from the user(s) (e.g., physical characteristics, such as but not limited to physical indicators of happiness or pleasure, displeasure or unhappiness, and/or the like), user behavior data (e.g., determine pain points of the users, enjoyment points, and/or the like, based on heatmaps of the user, surveys, interactions, keystrokes, tone, pitch, and/or the like), user interaction data (e.g., as the user interacts with websites, applications, graphical user interfaces, selectable icons, colors, how the user sounds, the user's eye movements, and/or the like), and/or the like.

In some embodiments, the user data may be collected via one or more sensors, via the keystrokes input at a user device (such as keyboard, cursor for a personal or desktop computer, and/or the like), via a camera, via a microphone, and/or the like. In some embodiments, the user data may comprise historical user data and/or current user data collected for each user. In some embodiments, the user data may be stored specifically to user accounts associated with the user the user data was collected from. In this manner, the system may correctly and distinctly store the user data for each user.

As shown in block 304, the process flow 300 may include the step of applying the user data to a digital twin associated with the user account. For instance, the system may generate and/or use a digital twin for each user the system is generating a customized prototype for. In this manner, each digital twin may be associated with a specific user account and associated user.

As used herein, the digital twin refers to a digital representation of an associated user, which is designed and configured to simulate decisions on behalf of the real-world user, mirror the user's behavior, characteristics, and performance (e.g., of tasks, reviews, interactions, and/or the like), and/or the like. In some embodiments, the digital twin may be generated using artificial intelligence, machine learning, simulation techniques and modeling techniques, and/or internet of things (IoT) components. In this manner, the system may generate the digital twin using current and/or historical user data, analyze the current and/or historical user data to predict outcomes and predict likely decisions by the associated user, and simulate/model the decisions via the digital twin.

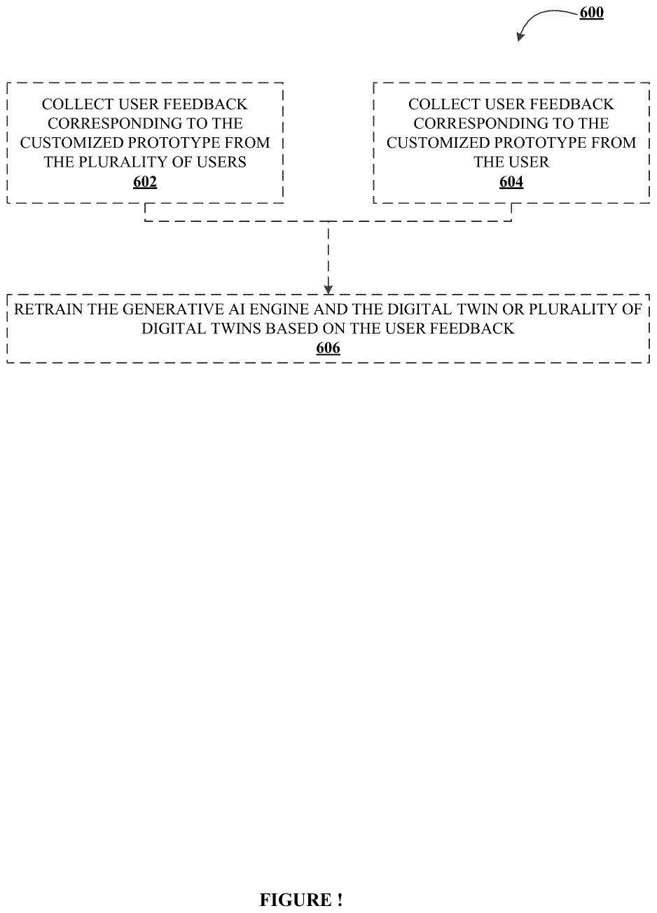

In some embodiments, the system may comprise a plurality of digital twins associated with a plurality of users, and the generative AI engine is trained with the user data from the plurality of users. Thus, and in some such embodiments, the system may generate a plurality of customized prototypes for a plurality of users and their digital twins, one customized prototype for a plurality of users (such as where a need is shared among the users), and/or the like. Such embodiments are described in further detail below with respect to FIG. 6.

As shown in block 306, the process flow 300 may include the step of applying the user data to a generative artificial intelligence (AI) engine. For example, the system may apply the collected user data (e.g., historical and/or current) to train the generative AI engine. For example, the generative AI engine may be trained specifically for a user, or generally for a plurality of users based on applying user data from a plurality of users to the generative AI engine. In some embodiments, the generative AI engine may be trained iteratively at each time user data is collected and applied to the generative AI engine. Additionally, and in some embodiments, the generative AI engine may be retrained automatically once the system receives feedback from the user and/or from the user's digital twin. Such an embodiment is described in further detail below with respect to FIG. 6. In some embodiments, the generative AI engine may be trained using the digital twin(s) of user(s). In some such embodiments, the digital twins may provide user data and/or digital twin feedback intended to mirror user feedback to the generative AI engine until the generative AI engine is trained.

As shown in block 308, the process flow 300 may include the step of generating, by the generative AI engine, a prototype for a user associated with the user account. For instance, the system may generate—using the generative AI engine—a prototype for the user(s) associated with the digital twin(s). The prototype may comprise at least one of an application, a product, a graphical user interface, and/or the like. Such a prototype may be generated to a meet a user need, or a plurality of user needs. In some embodiments, the generative AI engine may be trained on historical prototypes and their generation, and thus, the generative AI engine may be configured to generate new prototypes customized to the user(s) associated with the system.

As shown in block 310, the process flow 300 may include the step of analyzing, by the digital twin, the prototype. For example, the system may analyze—using the digital twin for the user that the prototype was generated for—the prototype and determine whether the prototype will likely be accepted by the user, enjoyed by the user, meet the needs of the user, and/or the like. Thus, and in some such embodiments, the digital twin may interact with the prototype, and based on the decisions, needs, and experiences of the digital twin, the system may update or change the prototype to better customize the prototype to the user's needs.

In some embodiments, and where the system comprises a plurality of digital twins for a plurality of users and the prototype is generated for the plurality of users, the generative AI engine may be trained with the user data from the plurality of users. In some such embodiments, the prototype is generated for the plurality of users and the prototype comprises a general user trend of those users. Such an embodiment is described in further detail below with respect to FIG. 6.

As shown in block 312, the process flow 300 may include the step of customizing the prototype for the user based on the analysis by the digital twin. For instance, the system may customize the prototype for the user based on updating or modifying the prototype after the digital twin(s) has analyzed the generative AI engine's prototype. In some embodiments, such a customization may comprise a change of a selectable icon (e.g., a button on a graphical user interface or within a graphical user interface of an application, text data, an image or graphic, a color of text or a graphic, and/or the like), a change of a physical placement on the prototype (e.g., the placement of a screen, button, sensor, and/or the like, a change to the image's location or text location, a change to the color of the text or image, and/or the like), and/or the like. Such a customization may be based on the interactions identified from the digital twin, and determination that the original prototype needed an update.

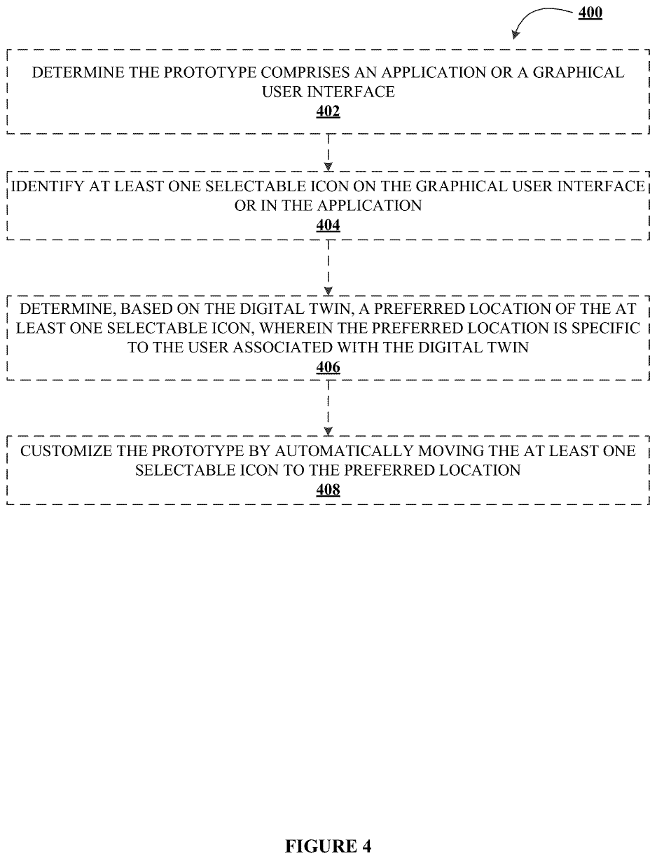

FIG. 4 illustrates a process flow 400 for customizing the prototype based on a preferred location of a selectable icon in the prototype, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, a generative artificial intelligence (AI) engine (e.g., such as the generative AI engine shown in FIG. 2) may perform some or all the steps described in process flow 400.

In some embodiments, and as shown in block 402, the process flow 400 may include the step of determining the prototype comprises an application or a graphical user interface. For example, and in some such embodiments, the system may determine the prototype comprises an application, such as a computer application comprising computer-readable program code. In some embodiments, the prototype comprising the application may additionally comprise a generated graphical user interface (or a plurality of graphical user interfaces). In some embodiments, the prototype may comprise a graphical user interface associated with an already-generated application. In some embodiments, such a graphical user interface may comprise one or more selectable icons, information rendered on the graphical user interface, graphics or images, and/or the like.

In some embodiments, and as shown in block 404, the process flow 400 may include the step of identifying at least one selectable icon on the graphical user interface or in the application. For example, and in some such embodiments, the system may identify the selectable icons (e.g., information/text, images, buttons, colors, and/or the like), rendered on the graphical user interface and the system may determine whether any of the information, icons, or images should be modified (e.g., the location changed, the webpage changed, color changed, and/or the like).

In some embodiments, and as shown in block 406, the process flow 400 may include the step of determining, based on the digital twin, a preferred location of the at least one selectable icon, wherein the preferred location is specific to the user associated with the digital twin. For instance, and in some such embodiments, the system may determine—based on the digital twin(s) associated with the user(s) for the prototype—a preferred location of the information, selectable icon, image, and/or the like on the graphical user interface. In some embodiments, the preferred location may be determined based on past interactions by the user (or plurality of users). For example, and where a user is determined to be legally blind in their left eye, the system may determine a preferred location on the right side of the graphical user interface to show all or most of the information, selectable icons, images, and/or the like. In some embodiments, the system may determine preferred colors for the user(s) and may update the selectable icon with the preferred color, update the text with the preferred color, and/or the like.

In some embodiments, and as shown in block 408, the process flow 400 may include the step of customizing the prototype by automatically moving the at least one selectable icon to the preferred location. For instance, and in some such embodiments, the system may customize the prototype by automatically moving or modifying the selectable icon, the information, the image, and/or the like based on the digital twin's interaction(s) with the original prototype. In some embodiments, and based on the example provided below, the digital twin of the user legally blind in their left eye may additionally comprise the same visual capabilities in the digital twin. Such a digital twin may interact with the original prototype and the system may determine the selectable icon, information, or images may be changed in the customized prototype which is customized to the user associated with the digital twin. Additionally, and in some embodiments, the customization of the prototype may comprise moving the selectable icon within the same original window or page it was initially, or the customization may comprise generating a new window or page for the selectable icon.

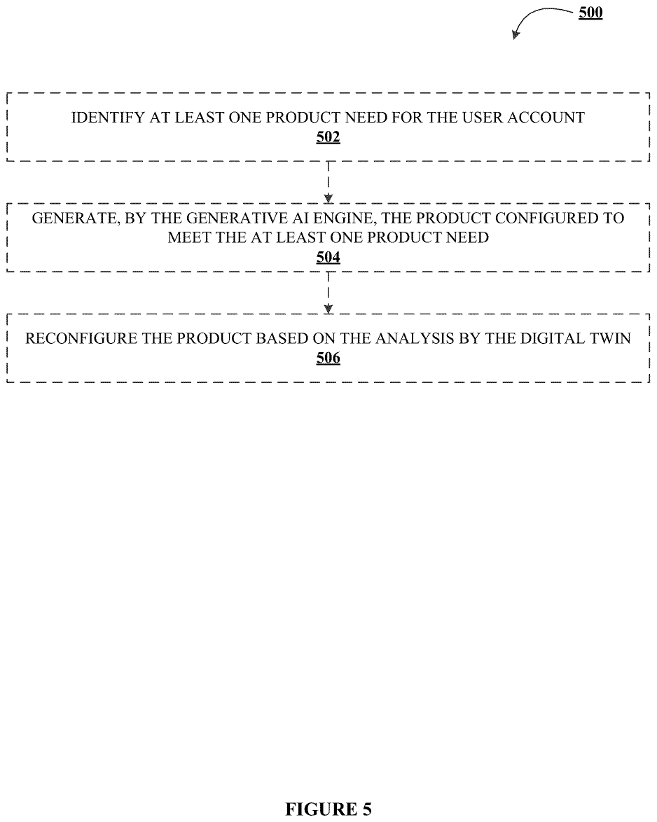

FIG. 5 illustrates a process flow 500 for determining a product need and generating a prototype to meet the product need, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, a generative artificial intelligence (AI) engine (e.g., such as the generative AI engine shown in FIG. 2) may perform some or all the steps described in process flow 500.

In some embodiments, and as shown in block 502, the process flow 500 may include the step of identifying at least one product need for the user account. For instance, and in some such embodiments, the system may identify at least one product need or consumer need by one or more users associated with the system (e.g., users or clients of the system, users or customers of a client of the system, and/or the like). In some embodiments, the product need may comprise a trend of what consumers, electronic users of an already existing application, users of a real-world product, and/or the like. In some embodiments, the product need may be specific to one user, or the product need may be based on collecting data from a plurality of users. For example, the system may collect user data for a plurality of users, identify a need among these users based on this user data, and then generate a product to meet a shared need for these users. In some embodiments, the product need may be determined based on survey data collected from one or more users, historical behavior data of the one or more users interacting with an existing product, historical physical feedback from one or more users, historical interaction data, and/or the like. In some embodiments, the user data may be based on data collected as the one or more users interact with current real-world products, or as the user interacts with current products that do not meet a current need but meet similar needs, and/or the like.

In some embodiments, the product need can be identified by the generative AI engine analyzing the user data and determining a need or want for the user(s) of the user data. In some embodiments, the product need may be identified by one or more users associated with the system and input (e.g., via a user input from a user device) the product need to the system. For example, the user(s) may input a product need directly to the system, and the system may use this received product need to generate the prototype.

In some embodiments, and as shown in block 504, the process flow 500 may include the step of generating, by the generative AI engine, the product configured to meet the at least one product need. For example, and in some such embodiments, the at least one prototype generated by the system may comprise a product. For example, and in some embodiments, the system may generate the prototype (or prototypes if the system generates a plurality of prototypes) comprising a product. As used herein, a product within the prototype may comprise a digital rendering or digital twin of a real-world product that could be used by one or more users of the system, by one or more users of a client of the system, and/or the like. For example, such a product may comprise an article of manufacture, a device, an image, a sound recording, an item for consumption, and/or the like, which may be used or consumed by a user. In some embodiments, the product within the prototype may comprise a digital representation or digital twin that mirrors a real-world product if the prototype was accepted by the user(s) the customized prototype was intended.

In some embodiments, and as shown in block 506, the process flow 500 may include the step of reconfiguring the product based on the analysis by the digital twin. For example, the system may reconfigure or customize the product based on the analysis by the digital twin to customize the product to the one or more users associated with the one or more digital twins interacting with the prototype.

In some embodiments, a plurality of customized products may be generated from the initial product (e.g., from block 504), and the plurality of customized products may each be customized to a specific user associated with each digital twin. For example, the generative AI engine may initially generate a prototype that may meet the product need for all the users that the product need was identified for, and then the system may customize (e.g., change or modify buttons on the product, a graphical user interface on the product, and/or other such components or configurations on the product) the initial product for each individual user the product need is identified.

In some embodiments, the system may generate a customized product that meets the product need(s) for each of the users associated with each digital twin that interacts with the product. In this manner, the system—using the generative AI engine and the digital twins—may generate a single product to meet the product need(s) for all the users associated with the digital twins, and thus, less computing needs and processing may be used to generate this product to meet all the needs of the users. In such embodiments, the system may generate the product using fewer computing resources, less manual intervention, while improving speed and efficiency in generating and customizing these products.

Thus, and in some such embodiments, the system may generate a prototype and customize the prototype based on currently available computing resources (e.g., cloud computing resources, classical computing resources, and/or the like), based on currently available storage resources, and/or based on prioritized product needs for one or more users. For instance, and in some embodiments, the system may prioritize the product needs based on the level of need for a product for a singular user (e.g., the user may not have any other product needs or one product need may be prioritized the highest) or a level of need across a plurality of product needs (e.g., one product need may be prioritized the highest based on a highest number of users comprising the same product need as compared to other product needs).

FIG. 6 illustrates a process flow 600 for collecting real time feedback from one or more users associated with one or more digital twins, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, a generative artificial intelligence (AI) engine (e.g., such as the generative AI engine shown in FIG. 2) may perform some or all the steps described in process flow 600.

In some embodiments, and as shown in block 602, the process flow 600 may include the step of collecting user feedback corresponding to the customized prototype from a plurality of users. For example, the system may collect user feedback for the customized prototype from the plurality of users interacting with and/or using the customized prototype. In some embodiments, the user feedback may be collected as user survey data, physical feedback data, user behavior data, user interaction data, and/or the like. Thus, and in some embodiments, the system may collect user feedback from user inputs (e.g., survey data) indicating their likes and dislikes of the customized prototype, from user interaction data (e.g., from behavior data or physical feedback, such as but not limited to indicators of enjoyment or non-enjoyment as the user interacts with the customized product), and/or the like. In some embodiments, all the user feedback data may be collected and sorted to a database or index comprising the other user data for an associated user account. Thus, and in some such embodiments, the system may store all the user data collected for a user to one or more storage locations and such user data may then be used to train the generative AI engine and/or to generate/update the user's digital twin. In some embodiments, and where the generative AI engine is trained for multiple users, the user feedback collected may be used to retrain the generative AI engine for those associated user accounts.

In some embodiments, and as shown in block 604, the process flow 600 may include the step of collecting user feedback corresponding to the customized prototype from the user. For instance, and additionally, and/or alternatively, the system may collect user feedback. Thus, and in some embodiments, the user data may comprise interactions and user inputs by the user from surveys presented to the user, physical feedback from the user, user behavior data, user interaction data, and/or the like. Similar to the collection of user feedback from a plurality of users, the system may also collect and store the user feedback for one user to a database or index associated with that specific user's user account. Further, and in some such embodiments, the collected user feedback may be used to retrain the generative AI engine and/or update the user's digital twin.

In some embodiments, and as shown in block 606, the process flow 600 may include the step of retraining the generative AI engine and the digital twin or the plurality of digital twins based on the user feedback. For example, and as mentioned above, the system may apply the collected user feedback to the generative AI engine(s) trained on the user data for the associated user account(s) and retrain the generative AI engine. Further, the system may also apply the collected user feedback to update the digital twin(s) for the user(s), such that the digital twin(s) may learn from the user feedback and generate better decisions and predictions based on the new user data (e.g., the user feedback) at future instances. Thus, and as understood by a person of skill in the art, both the generative AI engine and the digital twins may continuously learn and be updated as new user data and user feedback is collected.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating customized renderings for graphical user interfaces using generative AI and real-time feedback, the system comprising:
a memory device with computer-readable program code stored thereon;
at least one processing device operatively coupled to the memory device and at least one communication device, wherein executing the computer-readable code is configured to cause the at least one processing device to:
collect user data associated with a user account;
apply the user data to a digital twin associated with the user account;
apply the user data to a generative artificial intelligence (AI) engine;
generate, by the generative AI engine, a prototype for a user associated with the user account;
analyze, by the digital twin, the prototype; and
customize the prototype for the user based on the analysis by the digital twin.

2. The system of claim 1, wherein the analysis by the digital twin comprises at least one interaction by the at least one digital with the prototype.

3. The system of claim 1, wherein the at least one prototype comprises at least one of an application, a product, or a graphical user interface.

4. The system of claim 1, wherein the at least one prototype comprises an application or a graphical user interface, and wherein executing the computer-readable code is configured to cause the at least one processing device to:
identify at least one selectable icon on the graphical user interface or in the application;
determine, based on the digital twin, a preferred location of the at least one selectable icon, wherein the preferred location is specific to the user associated with the digital twin; and
customize the prototype by automatically moving the at least one selectable icon to the preferred location.

5. The system of claim 1, wherein the at least one prototype comprises a product, and wherein executing the computer-readable code is configured to cause the at least one processing device to:
identify at least one product need for the user account;
generate, by the generative AI engine, the product configured to meet the at least one product need; and
reconfigure the product based on the analysis by the digital twin.

6. The system of claim 1, wherein the user data is collected from at least one of historical surveys of the user, historical physical feedback, historical behavioral data, or historical interaction data.

7. The system of claim 1, wherein the digital twin comprises a plurality of digital twins associated with a plurality of users, and wherein the generative AI engine is trained with the user data from the plurality of users.

8. The system of claim 7, wherein the prototype is generated for the plurality of users and the prototype comprises a general user trend.

9. The system of claim 7, wherein executing the computer-readable code is configured to cause the at least one processing device to:
collect user feedback corresponding to the customized prototype from the plurality of users; and
retrain the generative AI engine and the plurality of digital twins based on the user feedback.

10. The system of claim 1, wherein executing the computer-readable code is configured to cause the at least one processing device to:
collect user feedback corresponding to the customized prototype from the user; and
retrain the generative AI engine and the digital twin based on the user feedback.

11. A computer program product for generating customized renderings for graphical user interfaces using generative AI and real-time feedback, wherein the computer program product comprises at least one non-transitory computer-readable medium having computer-readable program code portions embodied therein, the computer-readable program code portions which when executed by a processing device are configured to cause the processor to:
collect user data associated with a user account;
apply the user data to a digital twin associated with the user account;
apply the user data to a generative artificial intelligence (AI) engine;
generate, by the generative AI engine, a prototype for a user associated with the user account;
analyze, by the digital twin, the prototype; and
customize the prototype for the user based on the analysis by the digital twin.

12. The computer program product of claim 11, wherein the at least one prototype comprises an application or a graphical user interface, and wherein the computer-readable program code portions which when executed by the processing device are configured to cause the processor to:
identify at least one selectable icon on the graphical user interface or in the application;
determine, based on the digital twin, a preferred location of the at least one selectable icon, wherein the preferred location is specific to the user associated with the digital twin; and
customize the prototype by automatically moving the at least one selectable icon to the preferred location.

13. The computer program product of claim 11, wherein the at least one prototype comprises a product, and wherein the computer-readable program code portions which when executed by the processing device are configured to cause the processor to:
identify at least one product need for the user account;
generate, by the generative AI engine, the product configured to meet the at least one product need; and
reconfigure the product based on the analysis by the digital twin.

14. The computer program product of claim 11, wherein the user data is collected from at least one of historical surveys of the user, historical physical feedback, historical behavioral data, or historical interaction data.

15. The computer program product of claim 11, wherein the digital twin comprises a plurality of digital twins associated with a plurality of users, and wherein the generative AI engine is trained with the user data from the plurality of users.

16. A computer implemented method for generating customized renderings for graphical user interfaces using generative AI and real-time feedback, the computer implemented method comprising:
collecting user data associated with a user account;
applying the user data to a digital twin associated with the user account;
applying the user data to a generative artificial intelligence (AI) engine;
generating, by the generative AI engine, a prototype for a user associated with the user account;
analyzing, by the digital twin, the prototype; and
customizing the prototype for the user based on the analysis by the digital twin.

17. The computer implemented method of claim 16, wherein the at least one prototype comprises an application or a graphical user interface, further comprising:
identifying at least one selectable icon on the graphical user interface or in the application;
determine, based on the digital twin, a preferred location of the at least one selectable icon, wherein the preferred location is specific to the user associated with the digital twin; and
customize the prototype by automatically moving the at least one selectable icon to the preferred location.

18. The computer implemented method of claim 16, wherein the at least one prototype comprises a product, further comprising:
identifying at least one product need for the user account;
generating, by the generative AI engine, the product configured to meet the at least one product need; and
reconfiguring the product based on the analysis by the digital twin.

19. The computer implemented method of claim 16, wherein the user data is collected from at least one of historical surveys of the user, historical physical feedback, historical behavioral data, or historical interaction data.

20. The computer implemented method of claim 16, wherein the digital twin comprises a plurality of digital twins associated with a plurality of users, and wherein the generative AI engine is trained with the user data from the plurality of users.
